(19) United States
(12) Patent Application Publication
(10) Pub. No.: US 2018/0375264 A1
(43) Pub. Date: Dec. 27, 2018

(54) TERMINATED RF CONNECTOR

(71) Applicant: WILSON ELECTRONICS, LLC, St. George, UT (US)

(72) Inventor: Christopher Ken Ashworth, St. George, UT (US)

(21) Appl. No.: 16/016,074

(22) Filed: Jun. 22, 2018

Related U.S. Application Data
(60) Provisional application No. 62/525,630, filed on Jun. 27, 2017.

(51) Int. Cl. H01R 13/703; H01R 24/40; H01R 13/622; H04B 7/14

(52) U.S. Cl. CPC H01R 13/703; H01R 24/40; H01R 2103/00; H04B 7/14; H01R 13/622

(57) ABSTRACT

A repeater system includes an amplifier and a self-terminating connector configured to protect the amplifier. The self-terminating connector can include a switching element to couple the amplifier of the repeater to an impedance element of the self-terminating connector when an antenna is uncoupled from the self-terminating connector.

### RELATED APPLICATIONS

The present application claims the benefit of U.S. Provisional Patent Application No. 62/525,630 filed Jun. 27, 2017 with a docket number of 3969-114.PROV, the entire specification of which is hereby incorporated by reference in its entirety for all purposes.

### BACKGROUND

Wireless communication systems, such as cellular telephone systems, have become common throughout the world. A wireless repeater or booster is a radio frequency (RF) device used to amplify wireless communication for increased coverage, improved call clarity, and better data throughput. The repeater utilizes amplifiers to increase the signal strength between user equipment devices and base stations, cell towers, radio transmitters, access points and the like. The amplifiers are design for operating with a predetermined load impedance. However, during setup and operation, antennas may not be connected to the repeater before the amplifiers are powered up, or may be disconnected while the amplifiers are powered up. As a result, the load impedance of the amplifier may be outside the predetermined operating range of the amplifiers when one or more antennas are disconnected from the repeater. In such cases the amplifier may be damaged when operating with a load impedance outside the predetermined operating range. Therefore, there is a continuing need for improved wireless repeaters.

### DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 depicts a wireless repeater system, in accordance with an example;

FIGS. 2A and 2B depict a self-terminating connector, in accordance with an example;

FIGS. 3A and 3B depict a self-terminating connector, in accordance with an example; and

FIG. 4 depicts a wireless repeater system, in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION OF THE INVENTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

In one aspect, a wireless repeater or booster system can include an amplifier and a self-terminating connector. The self-terminating connector can be configured to protect the amplifier. The self-terminating connector can include a switching element configured to electrically couple an antenna to the amplifier of the repeater when the antenna is coupled to the self-terminating connector. When the antenna is uncoupled from the self-terminating connector, the amplifier can be electrically coupled to an internal impedance of the self-terminating connector.

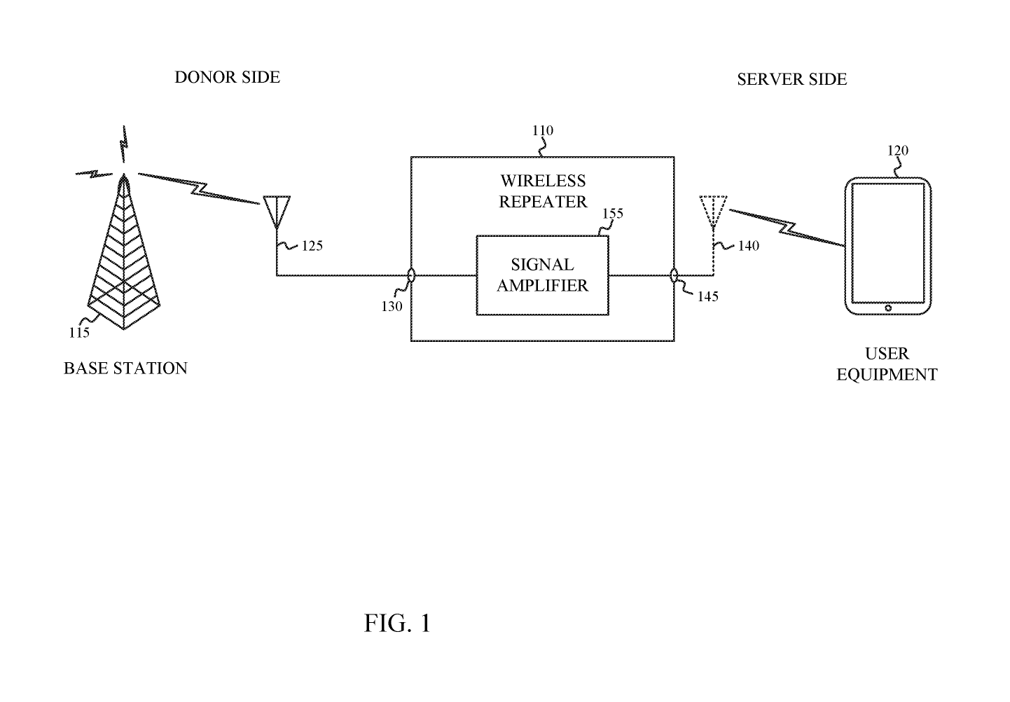

FIG. 1 depicts a wireless repeater system, in accordance with an example. The repeater 110 can be used to amplify communication signals between one or more base stations 115 and one or more user equipment devices 120. For a wireless telephone system, the base station 115 may be a cell tower, commonly referred to as an evolved node B (eNB) or next generation node B (gNB) and the user equipment 120 may be a smart phone, tablet, laptop, desktop computer, multimedia device such as a television or gaming system, cellular internet of things (CIoT) device, or other types of computing device. The repeater 110 can amplify the communication signals to increase coverage, improve call clarity, and/or increase data throughput.

In one aspect, the wireless repeater 110 can be used to amplify wireless communication signals in both uplink and downlink communications channels. One or more donor antennas 125 can be respectively coupled to one or more donor port connectors 130 of the repeater 110. The one or more donor antennas 125 can receive communication signals from one or more base stations 135 on one or more downlink communication bands or channels and send communication signals to the one or more base stations 135 on one or more uplink communication bands or channels. In addition, one or more server antennas 140 can be respective coupled to one or more server port connectors 145 of the repeater 110. The one or more server antennas 140 can receive communication signals from one or more user devices 150 on one or more uplink communication channels and send communication signals to one or more user devices 150 on one or more uplink communication channels. In one implementation, respective donor antennas 125 can be coupled to respective donor port connectors 130. Similarly, respective server antennas 140 can be coupled to respective server port connectors 145. The wireless repeater can also be configured to amplify time division duplex (TDD) channels.

In one aspect, the repeater 110 can include one or more signal amplifiers 155, one or more duplexers and/or couplers, one or more filters, and other circuits coupled between the one or more donor ports 130 and the one or more server ports 145. The antennas 125, 140 provide a load of a predetermined value on the output of respective amplifiers 155 of the repeater 110. However, one or more of the amplifiers 155 can be damaged as a result of poor return losses when no load is coupled to the output of the amplifiers 155. Therefore, one or more donor port connectors 130 and/or the one or more server port connectors 145 can self-terminate one or more respective amplifiers 155 of the repeater 110. One or more self-terminating donor port connectors 130 and/or one or more self-terminating server port connectors 145 can be configured to internally load the connector when a cable is uncoupled from the connector, and bypass the load when the cable is coupled to the connector. Therefore, the self-terminating donor port connectors 130 and/or self-terminating server port connectors 145 can protect the respective amplifiers 155 of the repeater 110 from damage when a respective antenna 125, 140 is un-coupled from the repeater 110.

While examples are provided for a repeater 110 are provided, this is not intended to be limiting. A transmitter can also include a connector that is self terminating. When an output, such as an antenna, is not coupled to the transmitter, a self-terminating connector, such as the self-terminating server port connector 145 can be used to protect amplifiers within the transmitter from damage when an antenna is un-coupled from the transmitter.

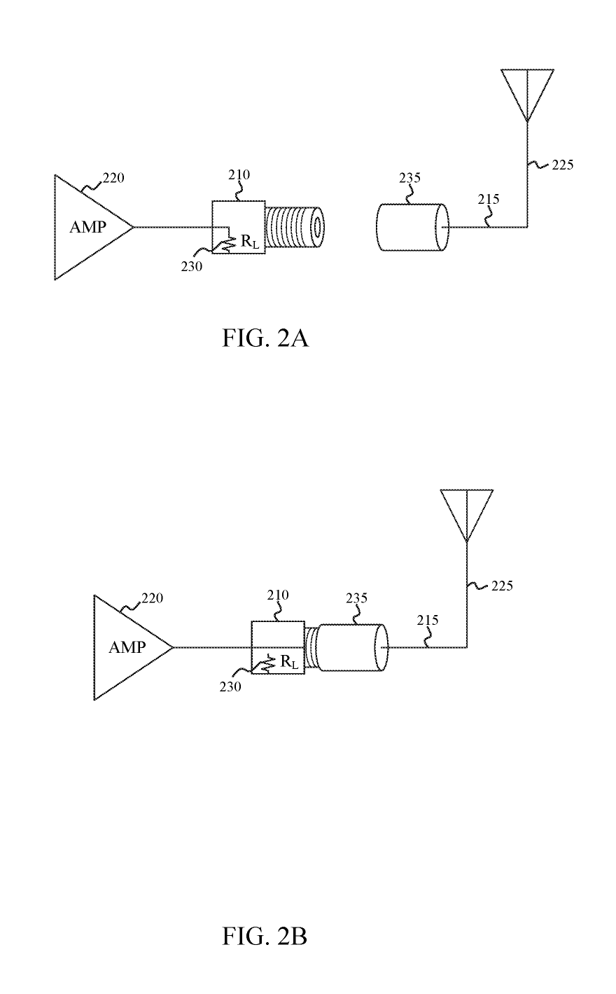

FIGS. 2A and 2B depict a self-terminating connector, in accordance with an example. In one aspect, the self-terminating connector 210 can couple a conductor of a cable 215 to an amplifier 220. For example, the self-terminating connector can couple the center conductor in a coaxial cable 215 of an antenna 225 to an RF power amplifier 220. The self-terminating connector 210 can include a securing element integral to the body of the self-terminating connector 210 for securing a mating connector 235 of a cable 215 to the self-terminating connection 210. The securing element can include a threaded ring, a threaded post, a compression fit ring, or a compression fit post, or other similar securing element.

In one aspect, the self-terminating connector 210 can be configured to reduce open circuit signal reflection to an amplifier 220. As illustrated in FIG. 2A, a load R_{L} 230 of the self-terminating connector 210 can be coupled to the amplifier 220 when a mating connector 235 of a cable 215 is uncoupled from the self-terminating connector 210. The load R_{L} 230 of the self-terminating connector 210 can be bypassed when the mating connector 235 of the cable 215 is coupled to the self-terminating connector 210 as illustrated in FIG. 2B.

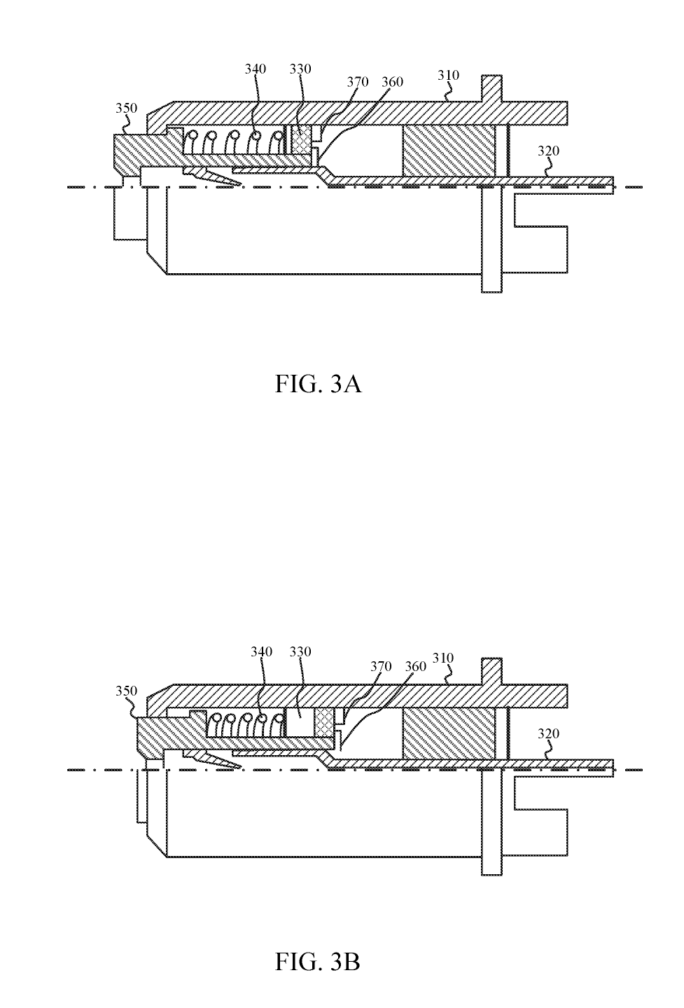

FIGS. 3A and 3B depict a self-terminating connector, in accordance with an example. In one aspect, the self-terminating connector includes a first conductor 310, a second conductor 320, an impedance element 330, and an actuating element 340, 350. The first conductor 310 can form at least a portion of a housing of the connector. The first conductor 310 can also include a connector mating area. In one instance, the connector mating area may be a threaded portion for threadedly attaching a mating connector of a cable to the self-terminating connector. In another instance, the connector mating area may be a compression fit portion for frictionally attaching a mating connector of a cable to the self-terminating connector. The second conductor 320 can be aligned coaxially with the body of the self-terminating connector. The actuating element 340, 350 can be disposed coaxially between the first conductor 310 and the second conductor 320.

In one aspect, the actuating element 340, 350 can include a resilient element 340 and an insulator element 350. The insulator element 350 can be biased between a first and second position by the resilient element 340. In one instance, the insulator element 350 can be captured within the housing of the connector. In one instance, the resilient element 340 can be a spring, coil, a compressible gas, liquid or solid, or similar element that biases the insulator element 350 between the first and second positions. In the first position, the insulator element 350 protrudes out of the housing from the mating area and the impedance element 330 can be electrically coupled between the second conductor 320 and the first conductor 310. In the second position, the insulator element 350 can be recessed into the housing from the mating area and the impedance element 330 can be electrically uncoupled from the second conductor 320.

In one example, the second conductor 320 can be electrically coupled to an output of an amplifier, and the first conductor 310 can be electrically coupled to a ground potential. When a mating connector of a cable is not coupled to the self-terminating connector, the insulator element 350 can be biased in the first position by the resilient element 340. In the first position, the insulator element 350 protrudes out of the housing from the mating area. When the insulator element 350 protrudes out of the housing, a first terminal 360 of the impedance element 330 can be electrically coupled to the second conductor 320 and a second terminal 370 of the impedance element 330 can be electrically coupled to the first conductor 310 as illustrated in FIG. 3A. Therefore, the output of the amplifier can be electrically coupled through the impedance element 330 to the ground potential. When a mating connector of a cable is coupled to the self-terminating connector the insulator element 350 can be biased in the second position by the resilient element 340 via the insulator element 350. In the second position, the insulator element 350 can be recessed into the housing from the mating area. When the insulator element 350 is recessed in the housing, the first terminal of the impedance element 330 can be electrically uncoupled from the second conductor 320 as illustrated in FIG. 3B. Therefore, the output of the amplifier can be electrically coupled through the second conductor 320 to a coaxial connector or cable coupled to the self-terminating connector.

In one instance, the self-terminating connector can mate with an F-type connector of a coaxial cable. In one instance, the impedance element can be a resistive load in the range of approximately 50-100 Ohms (Ω). In one instance, the self-terminating connector can be utilized in a repeater for one or more donor port connectors and or one or more server port connectors.

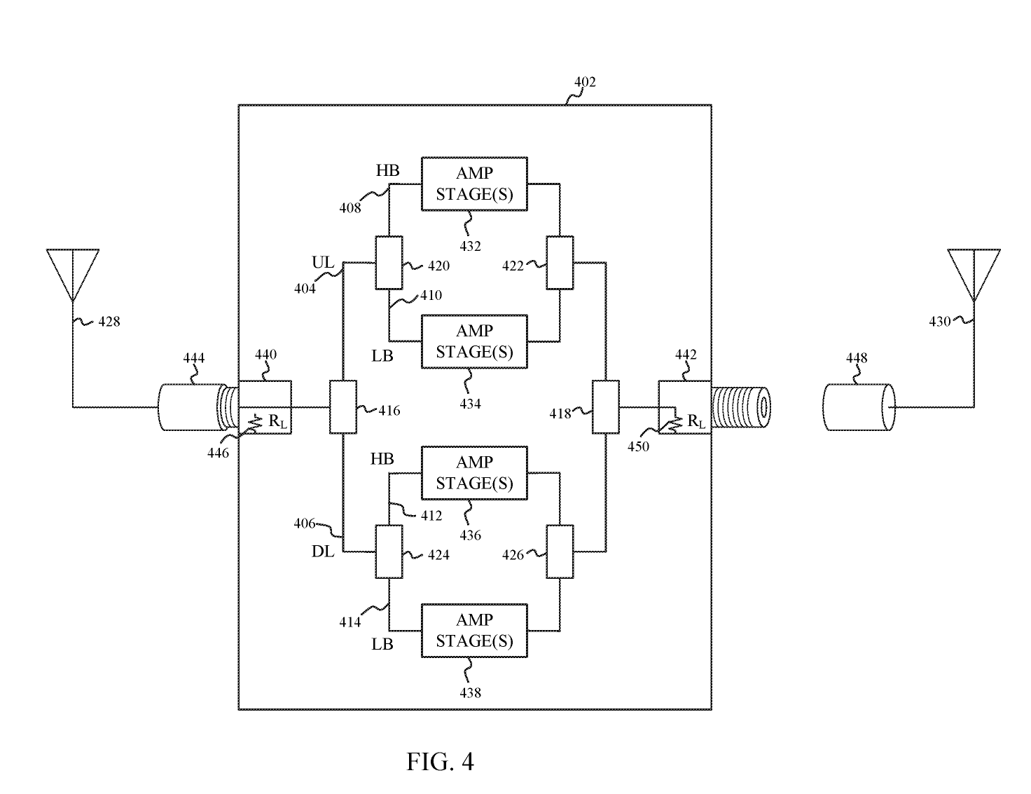

FIG. 4 depicts a wireless repeater system, in accordance with an example. In one aspect, the repeater 402 can amplify various types of radio frequency (RF) communication signals, such as cellular telephone, WiFi or AM/FM signals. In one instance, the RF communication signals can be cellular telephone RF signals, such as a Third-Generation Partnership Project (3GPP) Long Term Evolved (LTE) uplink and downlink signals. In one aspect, the repeater 402 can include one or more RF channels. The RF channels can include one or more uplink (UL) channels 404 and one or more downlink (DL) channels 406. In one instance, the uplink 3GPP LTE signals may operate at a first set of frequency bands and the downlink 3GPP LTE signal may operate at a second set of frequency bands. In one instance, the repeater can be configured to operate in one or more FDD bands or time division duplex (TDD) bands including FDD and TDD bands 1-71 listed in 3GPP Technical Specification (TS) 36.101 Version 14.3.0, Tables 5.5-1 and 5.6.1-1, and FDD Band 71 with an UL band from 663 Megahertz (MHz) to 698 MHz and a DL band from 617 MHz to 652 MHz.

In one instance, the one or more uplink (UL) channels 404 can include one or more high band (HB) channels 408 and one or more low band (LB) channels 410. Similarly, the one or more downlink (DL) channels 406 can include one or more high band (HB) channels 412 and one or more low band (LB) channels 414.

In one aspect, the repeater 402 can include one or more splitters 416, 418 and one or more diplexers 420-426, or similar circuits, to separate and recombine the RF communication signals received on respective one or more donor antennas 428 and one or more server antennas 430. Each channel of the repeater 402 can include one or more amplifier stages 432-438. In one aspect, the one or more amplifier stages 432-438 can be configured to amplify respective uplink and/or downlink 3GPP LTE signals.

In one aspect, the repeater 402 can include one or more self-terminating donor port connectors 440 and one or more self-terminating server port connectors 442. The one or more self-terminating donor port connectors 440 can provide for coupling a respective donor antenna 428 to corresponding splitters 416, 418, duplexers 420-426, and/or amplifier stages 432-438 of the repeater 402. Similarly, the one or more self-terminating server port connectors 442 can provide for coupling a respective server antenna 430 to corresponding 3969-114.NP splitters 416, 418, duplexers 420-426, and/or amplifier stages 432-438. The one or more donor port connectors 440 and/or one or more server port connectors 442 can be configured to internally load the connector to protect one or more of the amplifier stages 432-438 when an antenna is uncoupled from the connector. When an antenna is coupled to the connector, the load of the connector can be bypassed. For example, when a mating connector 444 on a cable of the donor antenna 428 is coupled to the donor port connector 440, a load 446 internal to the donor port connector 440 can be uncoupled from the corresponding splitters 416, 418, duplexers 420-426, and/or amplifier stages 432-438. Instead, the donor antenna 428, having an inherent load, can be coupled to corresponding splitters 416, 418, duplexers 420-426, and/or amplifier stages 432-438, as illustrated in FIG. 4. However, when a mating connector 448 on a cable of server antenna 430 is uncoupled from the server port connector 442, a load 450 internal to the server port connector 442 can be coupled to corresponding splitters 416, 418, duplexers 420-426, and/or amplifier stages 432-438, as illustrated in FIG. 4. In one aspect, the load 446, 450 internal to the self-terminating donor and/or server port connectors 440, 442 can be substantially equal to the load of the donor or server antenna 428, 420. For example, the donor and server antennas typically present a load of between 50-100 Ω. In such case, the internal load of the self-terminating donor and/or server port connectors 440, 442 can be a resistive load of approximately 50-100 Ω.

In one aspect, the self-terminating donor and/or server port connectors 440, 442 can include a first and second conductor. The first conductor can be coupled to a ground potential. The second conductor can be electrically coupled to corresponding splitters 416, 418, duplexers 420-426, and/or amplifier stages 432-438. A switching element of the connector can electrically couple a conductor of the mating connector to the second conductor of the self-terminating port connectors 440, 442, when the mating connector is coupled to the self-terminating port connector 440, 442 to a predetermined extent. For example, after a mating F-type connector of a cable for an antenna 428, 430 is partially threaded onto the self-terminating port connector 440, 442 the conductor of the cable can be electrically coupled to the second conductor of the self-terminating port connector 440, 442, which can in turn be coupled to corresponding splitters 416, 418, duplexers 420-426, and/or amplifier stages 432-438. When the mating connector is uncoupled, the switching element can electrically couple the second conductor of the self-terminating port connector 440, 442 through the load 446, 450 to the first conductor of the self-terminating port connector 440, 442. In such case, the output of one or more corresponding amplifier stages 432-438 can be electrically coupled through the load 446, 450 to the ground potential.

Accordingly, the self-terminating connectors advantageously protect one or more amplifiers of a repeater. The self-terminating connectors can reduce open circuit signal reflections to the amplifier. The self-terminating connectors can prevent damage to the amplifiers of the repeater when a corresponding antenna is uncoupled from a self-terminating connector. The self-terminating connectors can therefore increase product quality by reducing damage to one or more amplifiers, thereby reducing production reworking and/or repair. The self-terminating connector can also reduce customer returns, and/or increase customer satisfaction.

### EXAMPLES

The following examples pertain to specific technology embodiments and point out specific features, elements, or actions that can be used or otherwise combined in achieving such embodiments.

Example 1 includes a repeater comprising: an amplifier; and a self-terminating connector configured to reduce open circuit signal reflection to protect the amplifier.

Example 2 includes the repeater of example 1, wherein the self-terminating connector is configured to internally load the amplifier when an antenna is uncoupled from the self-terminating connector and bypass the load when the antenna is coupled to the self-terminating connector.

Example 3 includes the repeater of example 1, wherein a load of the self-terminating connector is coupled to the amplifier when a cable is uncoupled from the self-terminating connector; and the load of the self-terminating connector is bypassed when the cable is coupled to the self-terminating connector.

Example 4 includes the repeater of example 3, wherein the self-terminating connector mates with an F-type connector of the cable.

Example 5 includes the repeater of example 3, wherein the cable comprises a coaxial cable.

Example 6 includes the repeater of example 1, wherein the self-terminating connector comprises a jack connector or plug connector.

Example 7 includes the repeater of example 1, wherein the amplifier comprises a power amplifier.

Example 8 includes the repeater of example 1, wherein the amplifier comprises a radio frequency (RF) amplifier.

Example 9 includes a repeater comprising: an amplifier; and a self-terminating connector configured to protect the amplifier.

Example 10 includes the repeater of example 9, wherein the self-terminating connector includes, a first conductor forming at least a portion of a housing of the connector, wherein the housing includes a connector mating area; a second conductor electrically coupled to the amplifier; an impedance element; and a resilient element; and an actuating element biased between a first position and a second position by the resilient element, wherein the actuating element protrudes out of the housing from the mating area and the impedance element is electrically coupled between the second conductor and the first conductor in the first position, and wherein the actuating element is recessed into the housing from the mating area and the impedance element is electrically uncoupled from the second conductor in the second position.

Example 11 includes the repeater of example 10, wherein the first conductor is electrically coupled to a ground potential.

Example 12 includes the repeater of example 13, wherein the impedance element electrically coupled to the second conductor, when the actuating element is biased in the first position, electrically couples the amplifier to the ground potential through the impedance element.

Example 13 includes the repeater of example 10, wherein the first conductor comprises a body of the self-terminating connector.

Example 14 includes the repeater of example 13, wherein the second conductor is aligned coaxially within the body of the self-terminating connector.

Example 15 includes the repeater of example 13, wherein self-terminating connector further includes a securing element integral to the body of the self-terminating connector.

Example 16 includes the repeater of example 15, wherein the securing element comprises a threaded ring, a threaded post, a compression fit ring, or a compression fit post.

Example 17 includes the repeater of example 10, wherein the actuating element is disposed coaxially between first conductor and the second conductor.

Example 18 includes the repeater of example 17, wherein the actuating element comprises an electrical insulator and a resilient element.

Example 19 includes the repeater of example 18, wherein the resilient element comprises a spring, a coil, or a compressible gas, liquid or solid.

Example 20 includes the repeater of example 10, wherein the self-terminating connector comprises a jack connector or a plug connector.

Example 21 includes the repeater of example 10, wherein the impedance element comprises a resistive load.

Example 22 includes the a repeater comprising: an amplifier; and a connector including, a first conductor; a second conductor electrically coupled to the amplifier; an impedance element; and a switching element, wherein a conductor of a mating connector is electrically coupled through the second conductor to the amplifier when the mating connector is mechanically coupled to the connector to a predetermined extent, and wherein the second conductor is electrically coupled to the impedance element when the mating connector is mechanically uncoupled from the connector whereby the amplifier is electrically coupled through the impedance element to the first conductor.

Example 23 includes the repeater of example 22, wherein the impedance element is electrically uncoupled from the second conductor when the mating connector is mechanically coupled to the connector to the predetermined extent.

Example 24 includes the repeater of example 22, wherein the amplifier comprises a radio frequency (RF) amplifier.

Example 25 includes the repeater of example 22, wherein the amplifier comprises a power amplifier.

Example 26 includes the repeater of example 22, wherein the connector comprises a jack connector or a plug connector.

Example 27 includes the repeater of example 22, wherein the connector comprises a coaxial radio frequency (RF) connector.

Example 28 includes the repeater of example 22, wherein the mating connector comprises a F-type connector.

Example 29 includes the repeater of example 22, wherein the impedance element comprises a resistive load.

Example 30 includes the repeater of example 22, wherein the impedance element comprises a load of approximately 50-100 Ohms (Ω).

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry may include hardware, firmware, program code, executable code, computer instructions, and/or software. A non-transitory computer readable storage medium may be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term processor may include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module cannot be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as de facto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology may be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation may be made without the exercise of inventive faculty, and without departing from the principles and concepts of the technology. Accordingly, it is not intended that the technology be limited, except as by the claims set forth below.

What is claimed is:

1. A repeater comprising:
an amplifier; and
a self-terminating connector configured to reduce open circuit signal reflection to protect the amplifier.

2. The repeater of claim 1, wherein the self-terminating connector is configured to internally load the amplifier when an antenna is uncoupled from the self-terminating connector and bypass the load when the antenna is coupled to the self-terminating connector.

3. The repeater of claim 1, wherein a load of the self-terminating connector is coupled to the amplifier when a cable is uncoupled from the self-terminating connector; and
the load of the self-terminating connector is bypassed when the cable is coupled to the self-terminating connector.

4. The repeater of claim 3, wherein the self-terminating connector mates with an F-type connector of the cable.

5. The repeater of claim 3, wherein the cable comprises a coaxial cable.

6. The repeater of claim 1, wherein the self-terminating connector comprises a jack connector or plug connector.

7. The repeater of claim 1, wherein the amplifier comprises a power amplifier.

8. The repeater of claim 1, wherein the amplifier comprises a radio frequency (RF) amplifier.

9. A repeater comprising:
an amplifier; and
a self-terminating connector configured to protect the amplifier.

10. The repeater of claim 9, wherein the self-terminating connector includes,
a first conductor forming at least a portion of a housing of the connector, wherein the housing includes a connector mating area;
a second conductor electrically coupled to the amplifier;
an impedance element; and
a resilient element; and
an actuating element biased between a first position and a second position by the resilient element, wherein the actuating element protrudes out of the housing from the mating area and the impedance element is electrically coupled between the second conductor and the first conductor in the first position, and wherein the actuating element is recessed into the housing from the mating area and the impedance element is electrically uncoupled from the second conductor in the second position.

11. The repeater of claim 10, wherein the first conductor is electrically coupled to a ground potential.

12. The repeater of claim 13, wherein the impedance element electrically coupled to the second conductor, when the actuating element is biased in the first position, electrically couples the amplifier to the ground potential through the impedance element.

13. The repeater of claim 10, wherein the first conductor comprises a body of the self-terminating connector.

14. The repeater of claim 13, wherein the second conductor is aligned coaxially within the body of the self-terminating connector.

15. The repeater of claim 13, wherein self-terminating connector further includes a securing element integral to the body of the self-terminating connector.

16. The repeater of claim 15, wherein the securing element comprises a threaded ring, a threaded post, a compression fit ring, or a compression fit post.

17. The repeater of claim 10, wherein the actuating element is disposed coaxially between first conductor and the second conductor.

18. The repeater of claim 17, wherein the actuating element comprises an electrical insulator and a resilient element.

19. The repeater of claim 18, wherein the resilient element comprises a spring, a coil, or a compressible gas, liquid or solid.

20. The repeater of claim 10, wherein the self-terminating connector comprises a jack connector or a plug connector.
